(19) United States
(12) Patent Application Publication
(10) Pub. No.: US 2003/0148659 A1
(43) Pub. Date: Aug. 7, 2003

(54) Power connector

(76) Inventors: Robert W. Walker, Harrisburg, PA (US); John A. Root, Middletown, PA (US); Jeffrey A. Zeiders, Hummelstown, PA (US)

Correspondence Address: Michael Aronoff, Intellectual Property Law Department, Tyco Electronics Corporation, 307 Constitution Drive, M/S R20/2B, Menlo Park, CA, 94025-1164, US

(21) Appl. No.: 10/217,834

(22) Filed: Aug. 13, 2002

Related U.S. Application Data
(60) Provisional application No. 60/354,117, filed on Feb. 4, 2002.

(51) Int. Cl. H01R 13/60

(52) U.S. Cl. 439/537

(57) ABSTRACT

A connector assembly is shown which includes a receptacle connector and a plug connector assembly. The plug connector assembly is comprised of a plug housing and upper and lower flanges. The plug connector housing is spring-loaded rotationally relative to the upper and lower flanges, and includes a stop feature to orient the plug connector to the upper and lower flanges. The plug connector can rotate relative to the flanges, but there is always a home position for the plug polarized position.

This application claims the benefit of U.S. Provisional Patent Application Serial No. 60/354,117 filed Feb. 4, 2002, the complete disclosure of which is hereby expressly incorporated by reference.

### BACKGROUND OF THE INVENTION

The subject invention relates to a power connector for commercial and utility use, for example, for lighting fixtures and the like.

It is well known in the art of fixture systems, such as for lighting fixtures and ceiling fan fixtures, that most of the wiring between the fixture and the intended power wiring is done by hand, typically through conventional connectors known as wire nuts. Typically the ceiling of the building to include the fixture includes a junction box located where the fixture is to be located, with a portion of a power cable ready for connection. The person hanging the fixture typically requires a ladder to hold the fixture, and in many cases requires a second person to perform the connection function. It should be appreciated then that holding the fixture while at the same time connecting two wires with a wire nut is not an easy task to be completed.

Some manufacturers have provided an eyelet hook extending from the junction box, which can then hold the fixture while the wires are connected. While this design solves a portion of the problem, the fixture itself is awkward while hanging, and the hook itself becomes an encumbrance to the fixture once the wiring is completed.

Some manufacturers also provide a connection system such that one connector is in the junction box while the other connector is in the fixture such that longitudinal movement between the two connectors connects the fixture to the power conductors. This too has created some difficulty in that the fixture must be rotated to complete the installation, and therefore the connector within the fixture must always be properly oriented. Some installers can have the connector system, which is located in the fixture, rotated relative to the fixture which can cause damage to the connection system or a misconnection between the two connector halves, or simply difficult connection between the fixture and power connector.

The object of the invention is then to provide a solution to the above-mentioned shortcomings.

### SUMMARY OF THE INVENTION

The objects of the invention have been accomplished by providing an electrical connector for connecting a device to a power source. The device connector being connectable along a generally longitudinal axis, the device connector comprising a first housing portion, and a second housing portion which is rotatable relative to the first housing portion about the longitudinal axis. The second housing portion is spring-loaded relative to the first housing portion causing a moment on the second housing portion about the longitudinal axis.

In the preferred embodiment of the invention, the first and second housing portions also define a home position, whereby the second housing portion may be rotated relative to the first housing portion, yet spring loadably returned to the home position. Also preferably, the first and second housing portions define an extreme position of rotation. The first housing portion is comprised of a mounting member, which is preferably in the form of mounting flanges which overlap the second housing portion. The second housing portion includes an annular flange in surrounding relation, with an annular channel therein. The spring is positioned within the channel, with a first end connected to the first housing portion and a second end connected to the second housing portion. The first housing portion includes a recess into which the second housing portion flange resides. The annular channel includes stop walls, and the first housing member includes a tab member positioned between the stop walls, the second housing member being rotatable relative to the first housing member, with the home position and the extreme position being defined by the interference between the tab member and the stop walls. The first housing portion is defined by stamped metal shell halves, which trap between them the second housing portion flange.

In another aspect of the invention, an electrical connector assembly is comprised of plug and receptacle connector portions. The plug connector is connectable to the receptacle connector along a generally longitudinal axis. The plug connector comprises a housing portion and a mounting flange portion, which retains the housing portion in a position rotatable relative thereto about the longitudinal axis. The housing portion is spring-loaded relative to the flange portion causing a moment on the housing portion about the longitudinal axis.

In the preferred embodiment of this version, the housing portion and mounting flange portion define a home position, whereby the housing portion may be rotated relative to the mounting flange portion, yet spring loadably returned to the home position. The housing portion and mounting flange portion also define an extreme position of rotation. The housing portion and mounting flange portion have polarizing members to align them. The mounting flange portion is comprised of mounting flanges, which overlap the housing portion and trap it therebetween. The housing portion includes an annular flange in surrounding relation, with an annular channel therein. The spring is positioned within the channel, with a first end connected to the mounting flange portion and a second end connected to the housing portion. The mounting flange portion includes a recess into which the housing portion flange resides. The annular channel includes stop walls, and the mounting flange portion includes a tab member positioned between the stop walls, the housing member being rotatable relative to mounting flange portion, with the home position and the extreme position being defined by the interference between the tab member and the stop walls. The mounting flange portion is defined by stamped metal shell halves, which trap between them the second housing portion flange.

### BRIEF DESCRIPTION OF THE DRAWINGS

The invention will now be described by way of the drawing figures where:

FIG. 1 is a perspective of the connector system in a fully terminated position;

FIG. 2 is a perspective view showing the connector system of FIG. 1 in an exploded position;

FIG. 3 is a lower perspective view taken of the connector system of FIG. 2, as the connector system would be viewed from the ground;

FIG. 4 is a side plan view of the receptacle connector which is shown in FIG. 2 or 3;

FIG. 5 is a front plan view of the receptacle of FIG. 4;

FIG. 6 is a rear plan view of the receptacle of FIG. 4;

FIG. 7 is a cross-sectional view through lines 7-7 of FIG. 6;

FIG. 8 is a perspective view of the plug connector which is shown in FIG. 2 or 3;

FIG. 9 is a top plan view of the connector system of FIG. 8;

FIG. 10 is a rear plan view of the plug connector shown in FIG. 8;

FIG. 11 is a cross-sectional view through lines 11-11 of FIG. 10;

FIG. 12 is a cross-sectional view through lines 12-12 of FIG. 10; and

FIG. 13 is a perspective view of the cap for enclosing both the plug and receptacle connector shown in FIG. 1.

### DETAILED DESCRIPTION OF THE PREFERRED EMBODIMENT

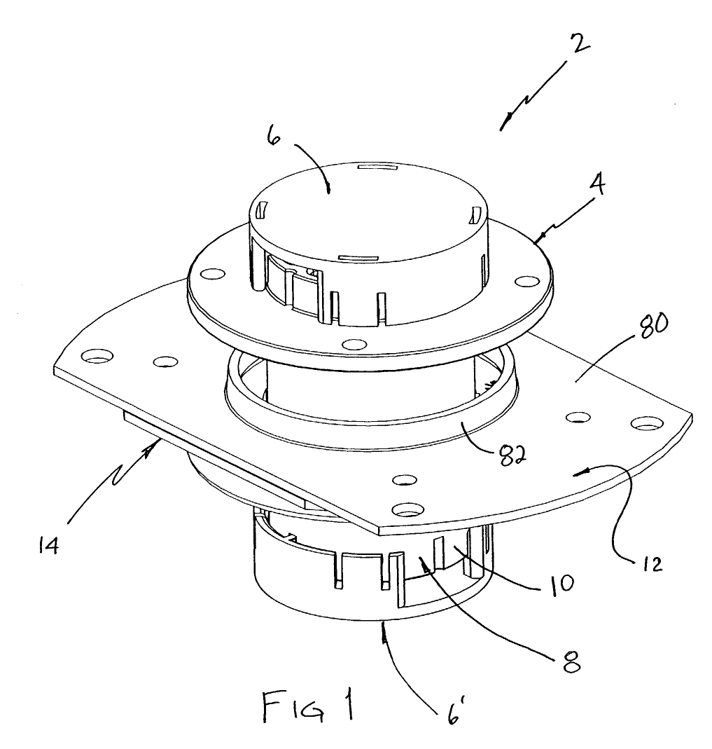

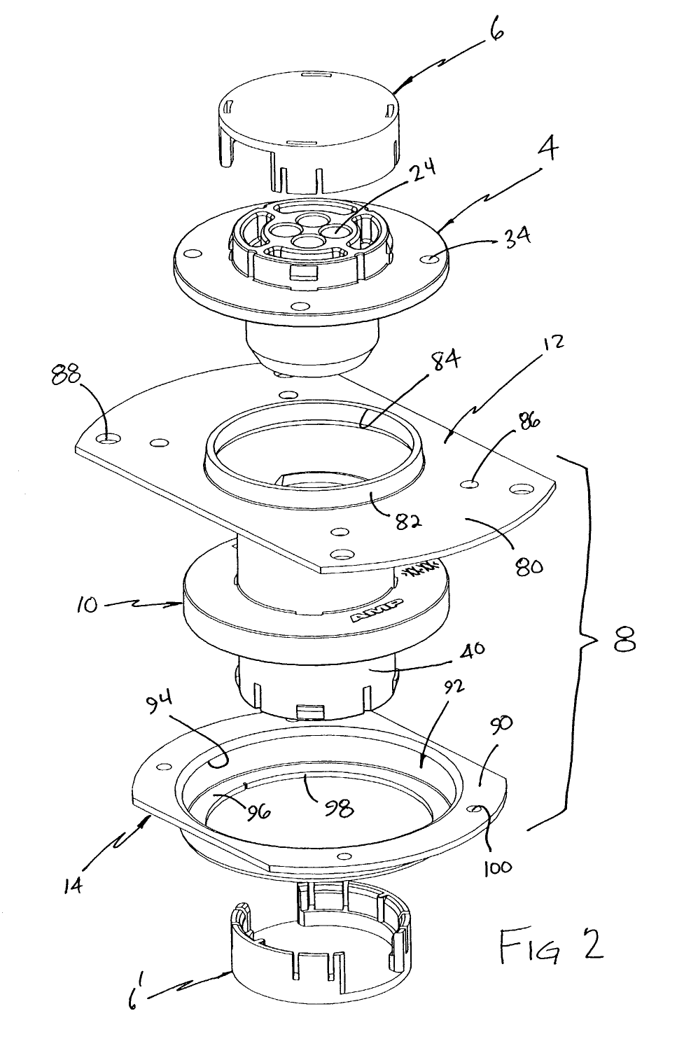

With respect first to FIGS. 1 and 2, the connector assembly of the present invention is shown generally at 2 and includes a receptacle connector 4, covered by a cap member 6. The plug connector assembly is shown generally at 8 to include a plug housing 10, an upper flange member 12 and a lower flange member 14. The plug housing 10 is also closed off by a cap member 6′, and it should be understood that caps 6 and 6′ are identical and thus only one will be described in great detail. It should be understood from viewing FIG. 2 that the receptacle connector 4 would be that connector intended for mounting in the ceiling or in the junction box, while the plug connector assembly 8 is intended for mounting within the fixture.

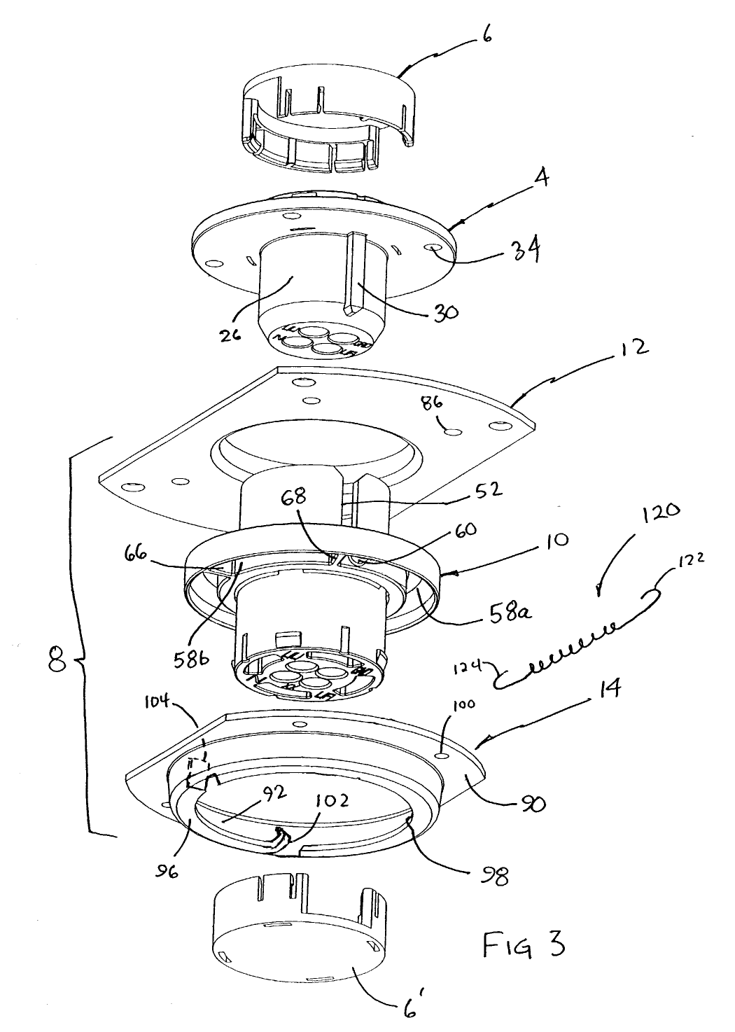

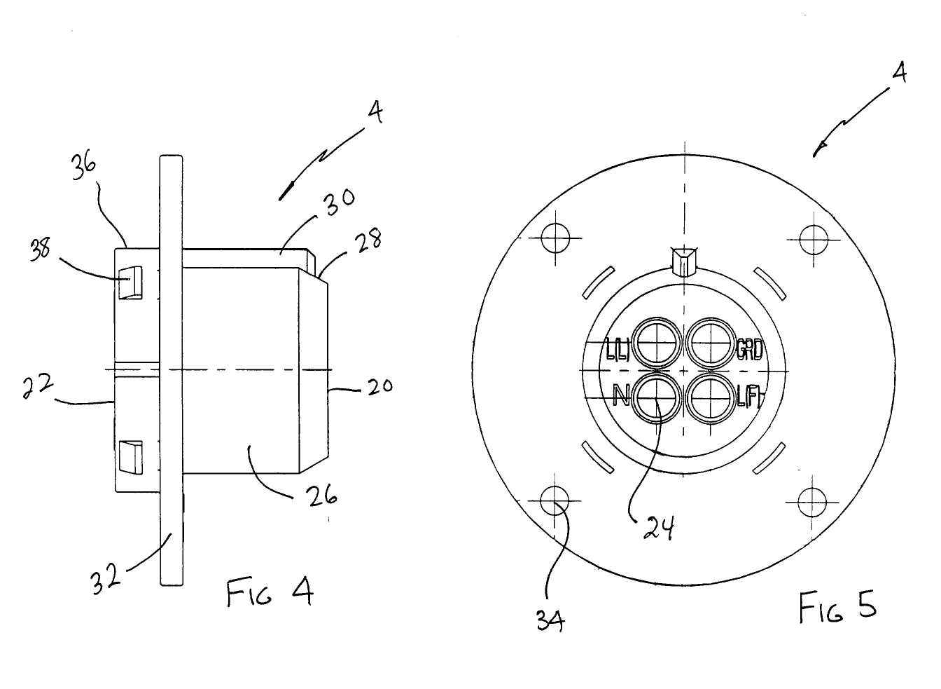

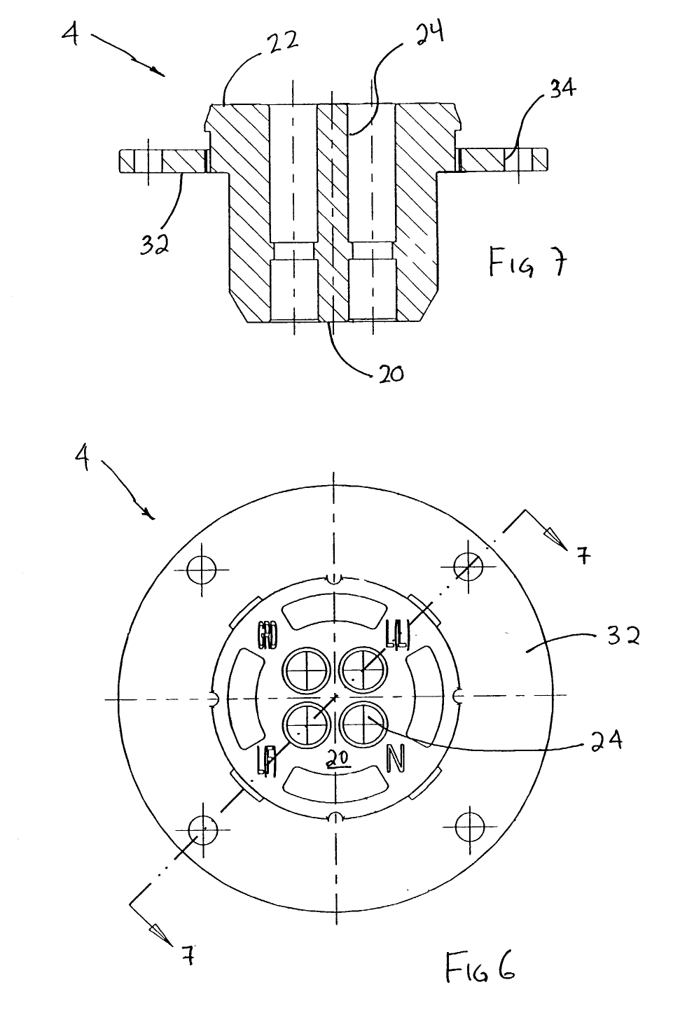

With respect now to FIGS. 4-7, the receptacle connector will be shown in greater detail. The receptacle connector 4 includes a mating face 20, a wire connecting face 22, and a plurality of terminal receiving passageways 24 extending therebetween. The receptacle connector housing 4 is generally cylindrical in nature to include a front mating shell 26 having a lead-in surface 28 and a polarizing rib at 30. A mounting flange 32 extends around the shell 26 and includes a plurality of mounting apertures 34. Finally, the plug receptacle includes a rear housing portion 36 having a plurality of latching members at 38 for retaining the cap 6 as will be described herein.

With respect now to FIGS. 8 through 12, the plug connector housing 10 will be described in greater detail. With respect first to FIG. 8, the plug housing 10 generally comprises a central housing portion 40 having a mating face 42, a wire connecting face 44, and a plurality of terminal receiving passageways 46 therebetween. A shroud 48 extends upwardly from the central body portion 40 to define a cylindrical wall having an inner surface at 50. The wall is interrupted at 52 to define a polarizing slot, which cooperates with the polarizing rib 30 as will be described further herein. The inner diameter of the wall 48 as defined by the surface 50 is profiled to receive the cylindrical shell portion 26 of the receptacle connector.

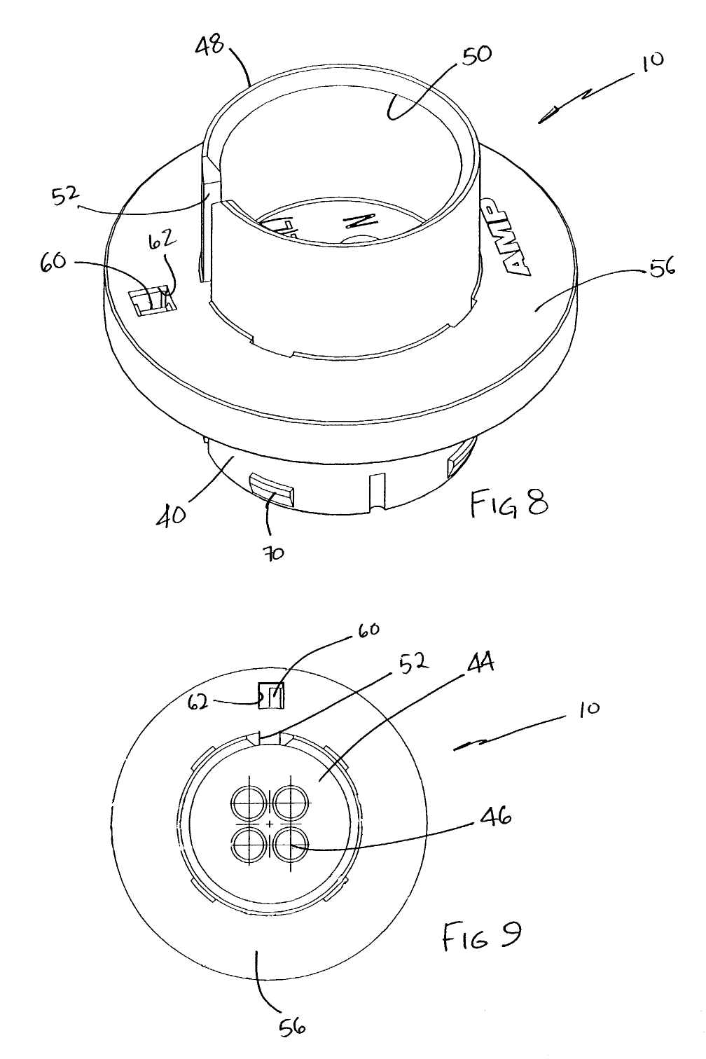

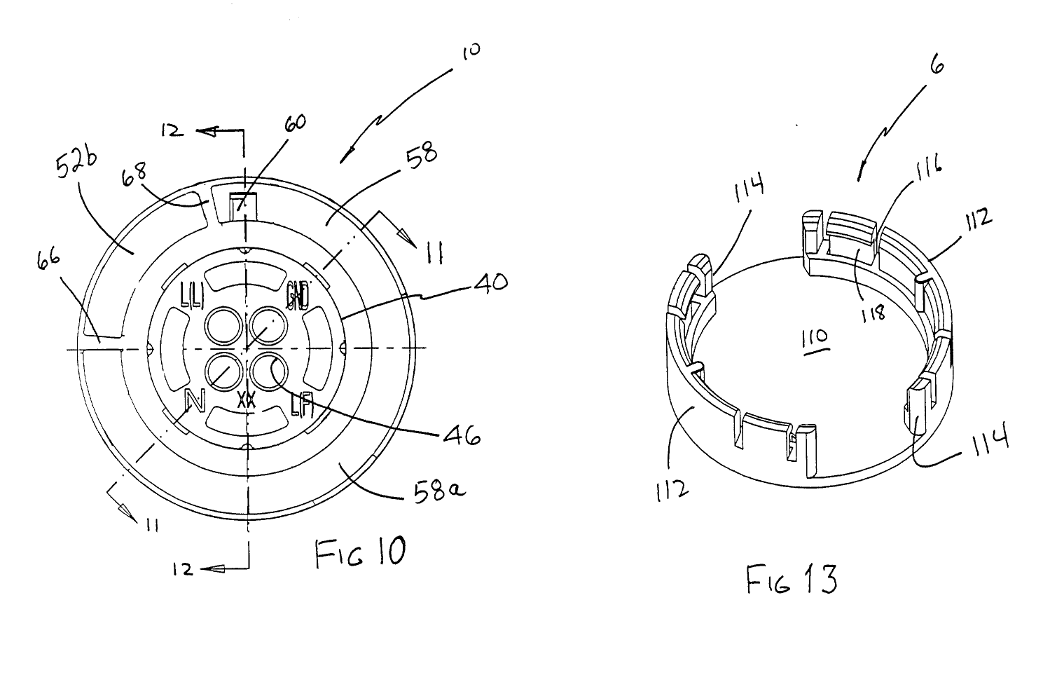

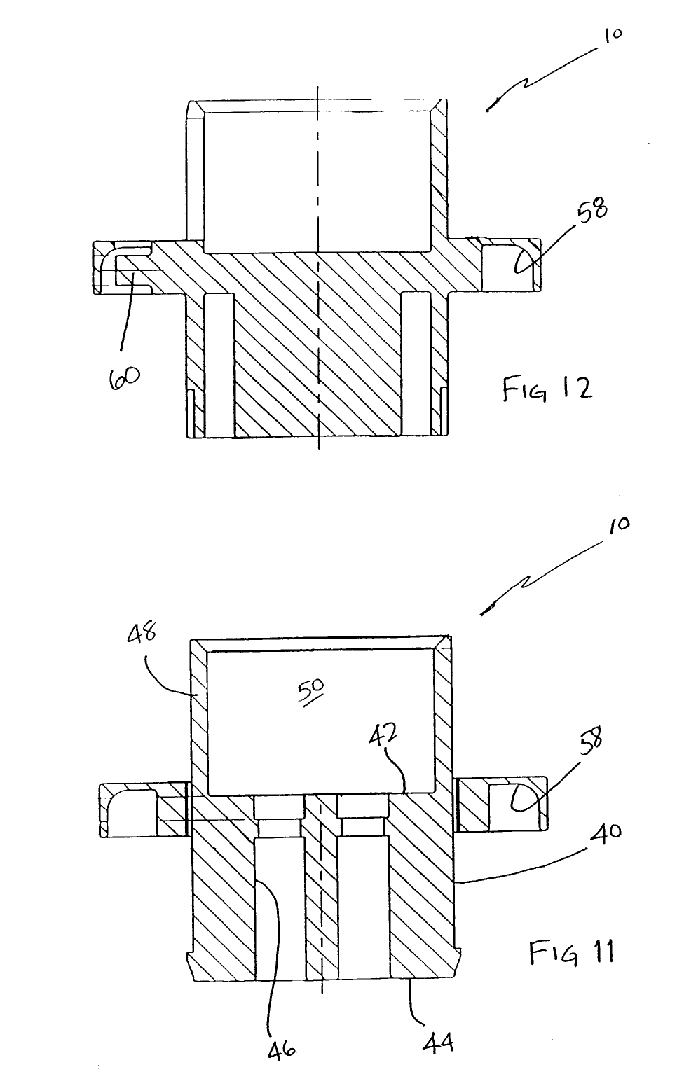

The plug connector 10 further comprises an annular ring at 56 and which opens downwardly to form an internal channel at 58, as best shown in FIG. 10. The ring 56 includes a spring retaining post at 60 extending into the channel as best shown in FIGS. 8 and 12. The post 60 is integrally molded with the remainder of the plug housing 10 and therefore an upper opening 62 (FIGS. 8, 9) is defined through the upper face of the annular ring 56 which defines the top portion of the post, whereas the remainder of the post is formed through the channel itself in the molding process. As best shown in FIG. 10, the channel 58 is interrupted by stop walls at 66 and 68 thereby defining two sections of the channel, a spring receiving section labeled 58A, and a positioning section shown at 52B, as will be described in greater detail herein. Finally, as shown in FIG. 8, plug housing 10 includes latching lugs at 70.

With respect now to FIGS. 1 and 2, upper flange 12 will be described in greater detail. Upper flange 12 includes a generally rectangular flange plate at 80 including an upturned annular ring 82 thereby defining a central opening at 84. The flange plate 80 includes a first set of mounting apertures 86 in a rectangular pattern, and a second set of mounting apertures 88 in a larger rectangular pattern.

With respect now to FIGS. 2 and 3, the lower flange member 14 will be described in greater detail. Flange member 14 includes a generally upper mounting ring at 90 and is drawn to define a recess at 92 which includes an internal annular wall at 94 and an end wall 96 having an opening therethrough at 98. It should be appreciated from viewing FIG. 2 that the opening 98 is profiled to receive the body portion 40 of plug connector 10 therethrough, while at the same time the recess 92 is profiled to receive the annular ring 56 therein. The mounting ring 90 includes mounting apertures at 100, which are in the same rectangular pattern as the mounting apertures at 86.

With respect now to FIG. 3, the end wall 96 includes a first tab section 102 struck therefrom and as shown is defined as a hook section, profiled to receive a spring end therearound. As also shown in FIG. 3, a second tab member 104 is struck from the end wall 96 and is defined as a generally upstanding rectangular tab. The function of tabs 102 and 104 will be described in greater detail herein.

Finally, with respect to FIG. 13, the retaining cap 6 includes a circular plate 110 having semi-cylindrical walls 112 upstanding therefrom, thereby defining wire receiving and exiting passageways at 114. Portions of the semi-cylindrical walls 112 are interrupted at 116 to define latching arms 118.

With respect now to FIG. 3, the assembly of the device and its operation will be described in greater detail. It should first be understood that a plurality of contact assemblies (not shown) will be loaded in both of the receptacle and plug housings 4, 10, for example pin and socket style contacts which are matable one to the other. It should also be understood that the receptacle connector 4 is appropriately mounted in the ceiling or junction box by way of retaining screws (not shown) positioned through the apertures 34 retaining the plug housing 4 in the ceiling with the cylindrical shell portion 26 and polarizing rib 30 extending downwardly into the room.

The plug assembly 8 is pre-assembled to the fixture by positioning a spring member 120 end position in channel 58, such that a spring end 124 is hooked around the post 60 to lie in channel portion 58A, whereas spring end 122 is hooked around tab portion 102 of the lower flange member 14. The housing portion 10 is then lowered into the recess 92 such that tab member 104 is within slot 58B and due to the spring load, will abut stop wall 66. The upper flange member 12 is now positioned over connector housing 10 such that the apertures 86, 100 are aligned. It should be appreciated that fastener members are used to retain the upper flange 12, lower flange 14, and intermediate connector housing 10 together. Prior to the installation of the plug assembly 8 to its associated fixture, the contacts are properly terminated to the wiring within the fixture.

The recess portion 92 is defined such that the plug connector housing 10 can rotate within the recess against the spring pressure. Thus, as shown in the perspective of FIG. 3, the connector housing 10 could rotate in the counter-clockwise position, whereupon the wall 66 will rotate away from tab portion 104. It should be appreciated that stop wall 68 is defined as an extreme position whereupon the connector housing cannot rotate beyond the interference between stop wall 68 and tab 104. This prevents damage to the wire cables, their connections, or the spring 120 itself. It follows then that, fastener members (not shown) can be positioned through apertures 88 of the top flange 12 to retain the entire plug assembly to the fixture to which it is to be connected. It should also be appreciated that the cover 6 and 6′ can be snapped in place at any time during the manufacture thereof to lace the wires in an organized manner for the wiring. The entire assembly of the plug connector assembly will be done with the assembly of the fixture or ceiling fan.

The installation of the entire fixture or ceiling fan is therefore accomplished as follows. It should be understood that a hanging bracket is included for mounting adjacent to or over the junction box and receptacle connector 4 for mounting the fixture and that the mounting bracket will require a proper orientation relative to the fixture. It is anticipated that the fixture itself will be polarized relative to the hanging bracket, and will rotate into a locked position, in a bayonet/locking lug style connection. Thus, the corresponding mounting elements on the lighting fixture or ceiling fan will cooperate with the orientation of the mounting bracket. It should be appreciated also that the connector assemblies 4, 6 will be appropriately oriented that when the lighting fixture is properly aligned vis-a-vis the mounting brackets, the mating connectors 4, 10 must also be properly polarized. This prevents the occurrence where the user, somehow in preparing to assemble and install the fixture or fan assembly, misaligns the receptacle connector assembly. Thus, in the present invention, the receptacle connector is always spring-loaded to the home position, where the bracket and fixture are properly aligned. This allows the installer to move the fixture into the mounting bracket, whereby both the fixture/bracket and mating connectors 4, 10 are polarized. The fixture is thereafter rotated, to lock the fixture to its associated bracket. As the connector is rotatable, the fixture is rotated relative to the connector, which remains fixed, and the fixture is locked in place. If the fixture must be taken down, the connector returns to its home position, where it again is polarized.

What is claimed is:

1. An electrical connector for connecting a device to a power source, the device connector being connectable along a generally longitudinal axis, said device connector comprising a first housing portion, and a second housing portion which is rotatable relative to said first housing portion about said longitudinal axis, said second housing portion being spring-loaded relative to said first housing portion causing a moment on said second housing portion about said longitudinal axis.

2. The electrical connector of claim 1, wherein said first and second housing portions also define a home position, whereby said second housing portion may be rotated relative to said first housing portion, yet spring loadably returned to said home position.

3. The electrical connector of claim 2, wherein said first and second housing portions also define an extreme position of rotation.

4. The electrical connector of claim 3, wherein said first housing portion is comprised of a mounting member.

5. The electrical connector of claim 4, wherein said first housing portion is comprised of mounting flanges which overlap said second housing portion.

6. The electrical connector of claim 3, wherein said second housing portion includes an annular flange in surrounding relation, with an annular channel therein.

7. The electrical connector of claim 6, wherein a spring is positioned within said channel, with a first end connected to said first housing portion and a second end connected to said second housing portion.

8. The electrical connector of claim 7, wherein said first housing portion includes a recess into which said second housing portion flange resides.

9. The electrical connector of claim 8, wherein said annular channel includes stop walls, and said first housing member includes a tab member positioned between said stop walls, said second housing member being rotatable relative to said first housing member, with said home position and said extreme position being defined by the interference between said tab member and said stop walls.

10. The electrical connector of claim 9, wherein said first housing portion is defined by stamped metal shell halves, and trap between them said second housing portion flange.

11. An electrical connector assembly comprised of plug and receptacle connector portions, the plug connector being connectable to said receptacle connector along a generally longitudinal axis, said plug connector comprising a housing portion, and a mounting flange portion which retains said housing portion in a position rotatable relative thereto about said longitudinal axis, said housing portion being spring-loaded relative to said flange portion causing a moment on said housing portion about said longitudinal axis.

12. The electrical connector assembly of claim 11, wherein said housing portion and mounting flange portion define a home position, whereby said housing portion may be rotated relative to said mounting flange portion, yet spring loadably returned to said home position.

13. The electrical connector assembly of claim 12, wherein said housing portion and mounting flange portion also define an extreme position of rotation.

14. The electrical connector assembly of claim 13, wherein said housing portion and mounting flange portion have polarizing members to align them.

15. The electrical connector assembly of claim 14, wherein said mounting flange portion is comprised of mounting flanges which overlap said housing portion and trap it therebetween.

16. The electrical connector assembly of claim 13, wherein said housing portion includes an annular flange in surrounding relation, with an annular channel therein.

17. The electrical connector assembly of claim 16, wherein a spring is positioned within said channel, with a first end connected to said mounting flange portion and a second end connected to said housing portion.

18. The electrical connector assembly of claim 17, wherein said mounting flange portion includes a recess into which said housing portion flange resides.

19. The electrical connector assembly of claim 18, wherein said annular channel includes stop walls, and said mounting flange portion includes a tab member positioned between said stop walls, said housing member being rotatable relative to mounting flange portion, with said home position and said extreme position being defined by the interference between said tab member and said stop walls.

20. The electrical connector assembly of claim 19, wherein said mounting flange portion is defined by stamped metal shell halves, and trap between them said second housing portion flange.
